(19) United States
(12) Patent Application Publication
(10) Pub. No.: US 2008/0235326 A1
(43) Pub. Date: Sep. 25, 2008

(54) Methods and Apparatus for Accelerating Web Browser Caching

(75) Inventors: Kaykhosrow Parsi, Reading, MA (US); Jeffrey T. Black, Boston, MA (US)

Correspondence Address: GOODWIN PROCTER LLP;PATENT ADMINISTRATOR, EXCHANGE PLACE, BOSTON, MA, 02109-2881, US

(73) Assignee: Certeon, Inc., Burlington, MA (US)

(21) Appl. No.: 11/944,127

(22) Filed: Nov. 21, 2007

Related U.S. Application Data
(60) Provisional application No. 60/919,269, filed on Mar. 21, 2007.

(51) Int. Cl. G06F 15/16

(52) U.S. Cl. 709/203

(57) ABSTRACT

Methods and apparatus for processing intercepted requests and responses related to document retrieval between client and server computers. In accordance with one embodiment of the present invention, document metadata from server responses are inspected and stored in a database by an acceleration device in the network path between client and server computers. The device inspects freshness verification requests sent from client to server computers and, based on information stored in its database, sends “not modified” responses back to the client computers without involving the server computers, thereby reducing network and server loads and improving response time. In further embodiments the device may maintain its database by sending document information requests to server computers and processing their subsequent responses.

### CROSS-REFERENCE TO RELATED APPLICATIONS

This application claims the benefit of U.S. Provisional Patent Application No. 60/919,269, filed on Mar. 21, 2007, which is hereby incorporated by reference as if set forth herein in its entirety.

### FIELD OF THE INVENTION

The present invention relates to methods and apparatus for communicating data and, more particularly, to methods and systems for accelerating the performance of web browser caches.

### BACKGROUND OF THE INVENTION

Web browsers are used by people to download and display elements of content, often referred to as documents, from Web servers over private networks and the Internet. Today's browsers typically incorporate a cache that is used to automatically store downloaded documents during a user's browsing activity. When a document is requested by the browser user, this cache is first checked to determine if it contains the requested document, and if so, the document may be fetched from the cache instead of being retrieved from the server. In this way, the cache improves the responsiveness of document display, and reduces loads on the network and server.

One aspect of caching in general is determining the freshness of the data in the cache. In the particular case of caching web browser data, this determination is typically supported by including, along with a cached document, certain metadata or associated information, which governs the utilization of that document. In order to avoid utilizing a document from the cache which may be out of date with respect to a later version on the server from which it was originally downloaded, the browser may take steps to verify its freshness prior to use. This generally involves sending to the server a freshness verification request. If the server determines that the cached document is fresh (i.e., that it has not been modified on the server since it was cached at the browser), then the server responds with an indication of this condition. In this case the browser is free to utilize the cached document. Alternatively, if the server determines that the cached document is not fresh (i.e., that it has been modified on the sever since it was cached at the browser), then the server responds by sending a new version of the document to the browser. The browser utilizes this new version and updates its cache by replacing the prior cached version.

### Typical HTTP GET Transaction Flow

Web browsers utilize the Hypertext Transfer Protocol (HTTP) to retrieve documents from web servers over private networks and the Internet. HTTP provides a number of methods that govern transactions between clients and servers. The GET method is commonly used to retrieve documents from a server to a client browser.

The HTTP GET method is comprised of a request message, sent from a client, such as a web browser, to a server, along with a response message sent from the server back to the client. Some pertinent forms of these messages are described below.

### Document Retrieval Request

This takes the form of an HTTP GET request where no condition is specified. The server is requested to return the document regardless of the time it was last modified.

Contains:
Method being employed in the request, specifically GET
Path on the server to the document
The specific version of HTTP being used

Example:
GET /path/index.html HTTP/1.1

### Document Retrieval Response

This takes the form of an HTTP 200 OK response where the server sends back document metadata, along with the document content.

Contains:
The specific version of HTTP being used
Return code of “200 OK” indicating the request is successful
Current date reported by the server
Cache control parameter, max_age, which specifies the number of seconds that the document may reside in the cache
Time of expiry of the document
Time the document was last modified on the server
ETag: Unique identifier for the specific document version
Length of the document
Type of content in the document
Document content

Example:
HTTP/1.1 200 OK
Date: Tue, 21 Nov 2006 13:19:41 GMT
Server: Apache/1.3.3 (Unix)
Cache-Control: max-age=3600
Expires: Thu, 30 Nov 2006 14:19:41 GMT
Last-Modified: Wed, 25 Oct 2006 02:28:12 GMT
ETag: “3e86-410-3596fabc”
Content-Length: 1022
Content-Type: text/html
<Document content . . . >

### Freshness Verification Request

This takes the form of an HTTP GET request where an “If-Modified-Since” condition is specified. Using this condition, the server is requested to return one of two possible responses: (1) if the document (on the server) has been modified after the date specified in the request, then a new version of the document is returned; (2) if the document has not been modified, then an indication to this effect is returned.

The client browser utilizes this form of HTTP GET to verify freshness of a document in its cache, specifically by employing the “If-Modified-Since” condition along with the date of the last modified time for the document as it resides in the client's browser cache.

Contains:
Method being employed in the request, specifically GET
Path on the server to the document
The specific version of HTTP being used
If-Modified-Since condition
Specified date

Example:
GET /path/index.html HTTP/1.1
If-Modified-Since: Mon, 23 Oct 2006 19:43:31 GMT

### “Not Modified” Response

In the case where the document on the server has been modified after the date specified in a freshness verification request, a new version of the document is returned in a manner identical to a document retrieval response described earlier.

In the case where document has not been modified, a “not modified” response is returned as described below.

Contains:
The specific version of HTTP being used
Return code of “304 Not Modified”
Current date reported by the server

Example:
HTTP/1.1 304 Not Modified
Date: Tue, 21 Nov 2006 13:19:41 GMT

### Document Information Request

This takes the form of an HTTP GET request where a range condition is specified. Using the range condition, the server is requested to return little or no actual content of the document. Only the document metadata in the response is of interest to the requester.

Contains:
Method being employed in the request, specifically GET
Path on the server to the document
The specific version of HTTP being used
Range condition

Example:
GET /path/index.html HTTP/1.1
Range: bytes=1-20

### Document Information Response

This takes the form of an HTTP 200 OK response where the server sends back document metadata, with little or no document content.

Contains:
The specific version of HTTP being used
Return code of “200 OK” indicating the request is successful
Current date reported by the server
Cache control parameter, max_age which specifies the number of seconds that the document may reside in the cache
Time of expiry of the document
Time the document was last modified on the server
ETag: Unique identifier for the specific document version
Length of the document
Type of content in the document
Little or no document content

Example:
HTTP/1.1 200 OK
Date: Tue, 21 Nov 2006 13:19:41 GMT
Server: Apache/1.3.3 (Unix)
Cache-Control: max-age=3600
Expires: Thu, 30 Nov 2006 14:19:41 GMT
Last-Modified: Wed, 25 Oct 2006 02:28:12 GMT
ETag: “3e86-410-3596fabc”
Content-Length: 1022
Content-Type: text/html
<Little or no document content . . . >

### SUMMARY OF THE INVENTION

Embodiments of the present invention concern a network device located between the browser and a server capable of inspecting the flow of client requests and server responses pertaining to document retrievals. In accord with the present invention, such a device may take steps to autonomously respond to client freshness verification requests on behalf of the server. This capability has the benefit of reducing load on the network and the server. Moreover, in the case where the intermediate device is co-located with the client (i.e., on the same LAN), and the network linkage between the intermediate device and the server includes a WAN, this capability has the added benefit of improving browser performance by eliminating request-response round-trips over the WAN. Because WAN latencies are generally long compared to LAN latencies, this capability may significantly improve browser performance.

Certain embodiments of the present invention provide a method for inspecting document freshness verification requests from a client and making “not modified” responses back to the client on behalf of a server, based on metadata derived from previous document retrieval request-response transactions. In one embodiment, the invention can be applied to HTTP GET request-response transactions between web browsers and web servers. By employing this invention within an acceleration device intermediate in a network path between client computers running a web browser, and servers responsive to such browsers, the benefits of reducing network and server load and improving browser performance can be achieved.

In one aspect, the present invention relates to a method for accelerating freshness verification requests. A document retrieval response is received from a server, and information is extracted from the document retrieval response. The extracted information is stored in a database. A freshness verification request is received from the client and extracted information stored in the database is consulted to determine if the freshness verification request can be serviced without forwarding the freshness verification request to a server.

The document retrieval response may include, for example, an HTTP 200 OK message. The freshness verification request may include, for example, an HTTP GET message with an If-Modified-Since condition. In one embodiment, the method further includes the transmission of a “not modified” response to the client, such as an HTTP 304 Not Modified message.

In another embodiment, the method includes receiving a document retrieval request from a client, forwarding the document retrieval request to a server, and forwarding the document retrieval response to a client. The document retrieval request may include, for example, an HTTP GET message without an If-Modified-Since condition.

In still another embodiment, the method includes transmitting a document information request to the server, receiving a document information response from the server, extracting information from the received document information response, and storing the extracted information in a database. The transmittal of a document information request may be made contemporaneously upon the receipt of the freshness verification request, subsequent to the receipt of the freshness verification request, or independent of the receipt of the freshness verification request. The document information request may include, for example, an HTTP GET message with a range condition. The document information response may include, for example, an HTTP 200 OK message with little or no document content.

In another aspect, the present invention relates to an apparatus for accelerating freshness verification requests. The apparatus includes a receiver, a database, and a processor. The receiver receives a document retrieval response from a server and a freshness verification request from a client. The processor extracts information from a received document retrieval response and stored the extracted information in the database, and consults the database to determine if a freshness verification request can be serviced without forwarding the freshness verification request to a server.

The document retrieval response may include, for example, an HTTP 200 OK message. The freshness verification request may include, for example, an HTTP GET message with an If-Modified-Since condition. In one embodiment, the apparatus also includes a transmitter for transmitting a “not modified” response to the client, such as an HTTP 304 Not Modified message.

In another embodiment, the receiver receives a document retrieval request from a client and the apparatus includes a transmitter for forwarding the document retrieval request to a server, and forwarding the document retrieval response to a client. The document retrieval request may include, for example, an HTTP GET message without an If-Modified-Since condition.

In still another embodiment, the transmitter transmits a document information request to the server, the receiver receives a document information response from the server, and the processor extracts information from the received document information response and stores the extracted information in the database. The transmitter may transmit the document information request contemporaneously upon the receipt of the freshness verification request, subsequent to the receipt of the freshness verification request, or independent of the receipt of the freshness verification request. The document information request may include, for example, an HTTP GET message with a range condition. The document information response may include, for example, an HTTP 200 OK message with little or no document content.

### BRIEF DESCRIPTION OF THE DRAWINGS

The foregoing and other objects, features, and advantages of the present invention, as well as the invention itself, will be more fully understood when read together with the accompanying drawings, in which:

FIG. 1 depicts typical document retrieval and freshness verification requests and responses between client and server computers interconnected via a routing node and LAN and WAN network facilities;

FIG. 2 depicts an acceleration device incorporating an embodiment of the invention and operating to accelerate freshness verification requests and responses between client and server computers likewise interconnected via a routing node and LAN and WAN network facilities;

FIG. 3 presents a block diagram of the acceleration device of FIG. 2; and

FIGS. 4A-4C illustrates a flowchart of a method for accelerating freshness verification requests in accord with one embodiment of the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

As mentioned above, one embodiment of the invention provides an acceleration device intermediate in the network path between client computers running web browsers and web servers. In this embodiment, the acceleration device processes HTTP GET requests and their related responses. Also in this embodiment, the acceleration device performs other processing steps pertaining to accelerating transmissions over the network, such as data reduction, caching, and protocol optimization.

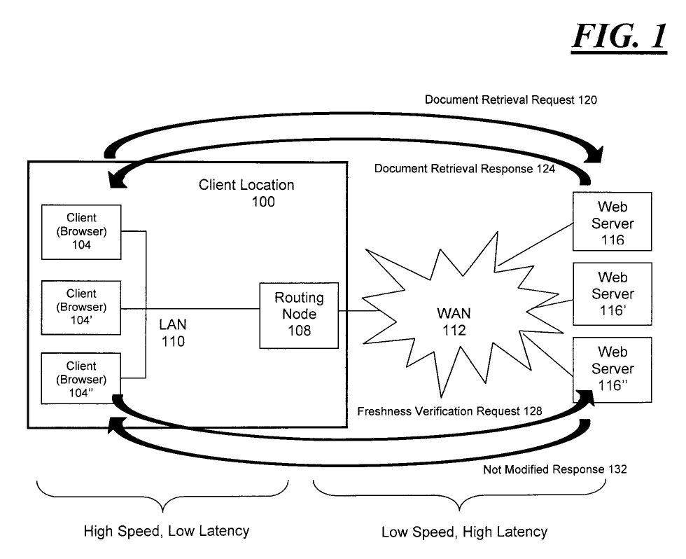

FIG. 1 shows a client location 100 where one or more client computers 104, each employing a web browser, are interconnected with a routing node 108 over LAN facilities 110. Such facilities typically operate as 100 to 1000 mbps throughput, with transmission latencies below a few milliseconds. The routing node is further connected to a WAN 112 with the ability to route traffic to a multiplicity of servers 116 which are responsive to document retrieval requests 120 and freshness verification requests 128 made by the respective browsers. The WAN 112 typically has performance characteristics inferior to LAN facilities, with throughput often ranging from 0.10 to 10 mbps and latencies ranging from 50 to 1000 milliseconds. Because each client request and server response must involve transit over the WAN 112, the time needed to complete the transaction is dominated by the inferior bandwidth and latency characteristics of the WAN 112. Therefore, poor WAN performance results in slow application responsiveness as perceived by the browser user.

It is important to note that all client requests, including freshness verification requests 128, must transit the WAN 112 from the client 104 to the server 116. Likewise, all server responses, including document retrieval responses 124 and “not modified” responses 132, must transit the WAN 112 from the server 116 back to the client 104. Therefore, even in cases where a document residing in a browser cache is up-to-date with respect to its originating server, the performance of a freshness verification request 128/“not modified” response 132 transaction may have a detrimental effect on browser performance. Eliminating unnecessary such transactions from the WAN has the benefit of improving performance and is the basis for the present invention.

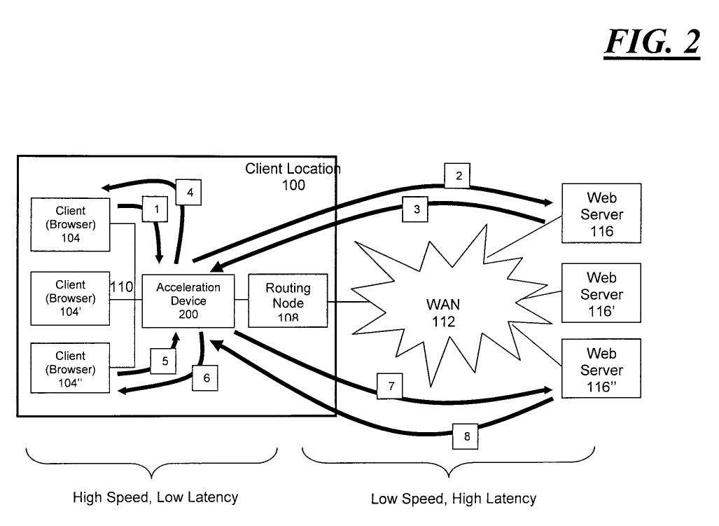

FIG. 2 illustrates the general flow of request and response messages between a multiplicity of client computers 104 each employing a web browser, a multiplicity of web servers 116 responsive to the browsers, and an acceleration device 200 in the network path between such clients 104 and servers 116. More specifically, as depicted the acceleration device 200 is interconnected with the clients 104 over LAN facilities 110, and with the web servers 116 via a routing node 108 over WAN facilities 112.

Referring to FIG. 2, a client 104, employing a browser, sends a document retrieval request (1) to a web server 116 which is intercepted by the acceleration device 200. The acceleration device 200 forwards the request (2) to the designated web server 116. The server 116 responds with a document retrieval response (3), which is also intercepted by the acceleration device 200. The acceleration device 200 forwards the response (4) to the client 104. Upon interception, the acceleration device 200 inspects metadata in the response and records certain information in a database. Upon receiving the document retrieval response (4), the browser in client 104 may utilize the document and store it in its cache for subsequent use. In a similar manner, clients 104′ and 104″, each employing a browser, may also exchange document retrieval requests and responses with the web server 116, such requests and responses likewise being processed by the acceleration device 200.

Again referring to FIG. 2, a client 104 may subsequently send a freshness verification request (5) to a server 116 to verify that a previously cached document is not out-of-date with respect to the server 116 from which it originated. This request is intercepted by the acceleration device 200. Based on information stored in its database derived from previous document retrieval request-response transactions, the acceleration device 200 may send a “not modified” response (6) directly back to the client 104. This response, coming from the acceleration device 200 rather than the server 116, has the benefit of improved performance and reduced load on the WAN 112 and the server 116. In addition, the acceleration device 200 may send a document information request (7) to the server 116. This document information request (7) may be sent contemporaneously upon the receipt of the freshness verification request (5), some time subsequent to the receipt of the freshness verification request (5), or independent of the freshness verification request (5), for example, upon system initialization, when the accelerator device 200 seeks to verify the contents of its existing database. In response, the server 116 sends a document information response (8) back to the acceleration device 200, which updates its database with information derived from the response. In a similar manner, clients 104′ and 104″ may also send freshness verification requests to the web server 116, such requests likewise being processed by the acceleration device 200.

Still referring to FIG. 2, clients 104, 104′, and 104″ may also exchange document retrieval requests and responses with, and send freshness verification requests to, web servers 116′ and 116″, such requests and responses likewise being processed by the acceleration device 200.

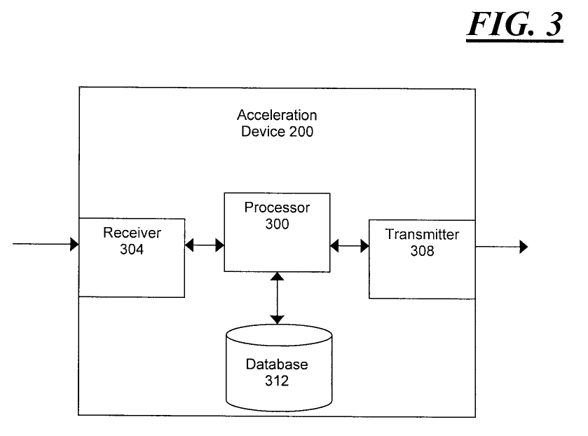

FIG. 3 presents one embodiment of the acceleration device 200 comprising a processor 300, a receiver 304, a transmitter 308, and a database 312. In operation, the acceleration device 200 receives messages at the receiver which are subsequently processed by the processor 300. Pertinent information is stored by the processor 300 in the database 312 for later retrieval and usage. Messages may be forwarded or internally generated and transmitted using transmitter 308. One embodiment of such an acceleration device 200 is a rack-mount computer having non-volatile storage and network connectivity.

In this embodiment, the acceleration device 200 maintains the following information in the database 312:
document_table—A table wherein each entry contains the following information:
   name—name of a document retrievable via a document retrieval request-response transaction. In the particular case of the HTTP GET mechanism, this may be a Uniform Resource Locator (URL)
   last_checked_time—time the entry was last updated with information from the server
   expiration_time—time after which the document should not be utilized by a cache
   last_modified_time—time the document was last modified on the server
max_table_age—The maximum amount of time since it was last updated that an entry in the document_table remains valid.
refresh_age—The maximum amount of time since it was last updated that an entry in the document_table may used to construct a “not modified” response without triggering an update via a document information request.

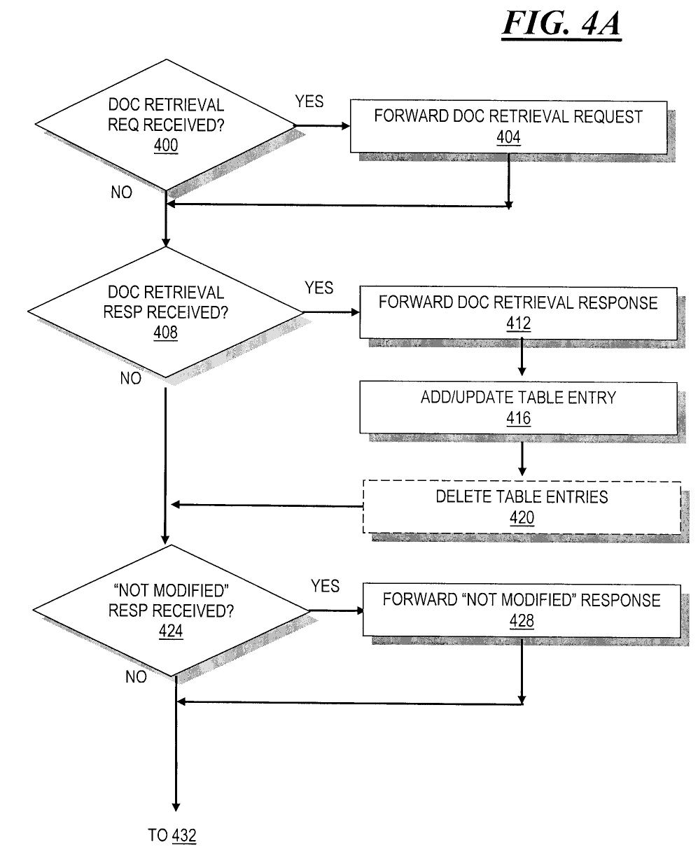

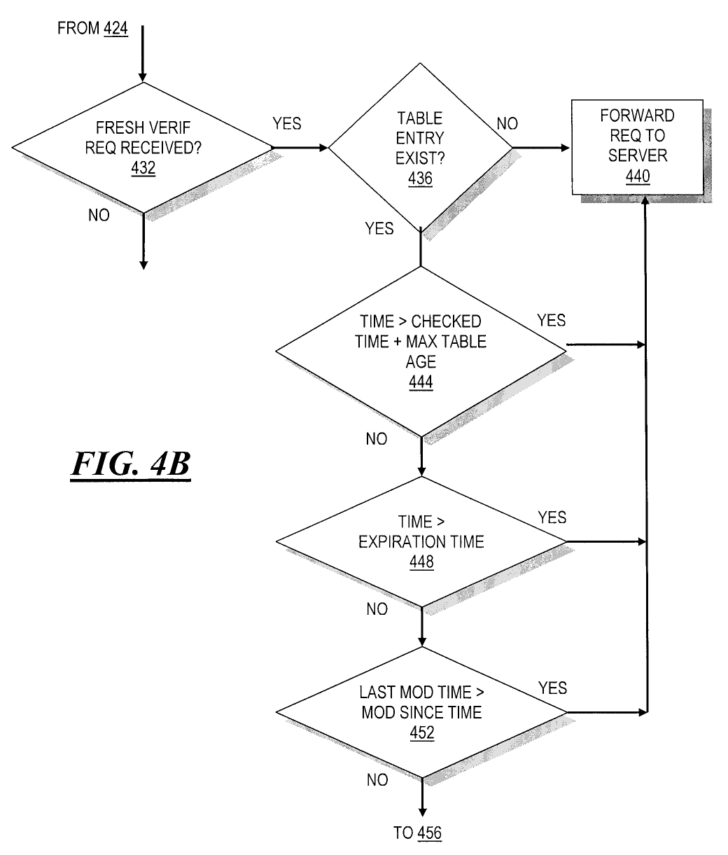

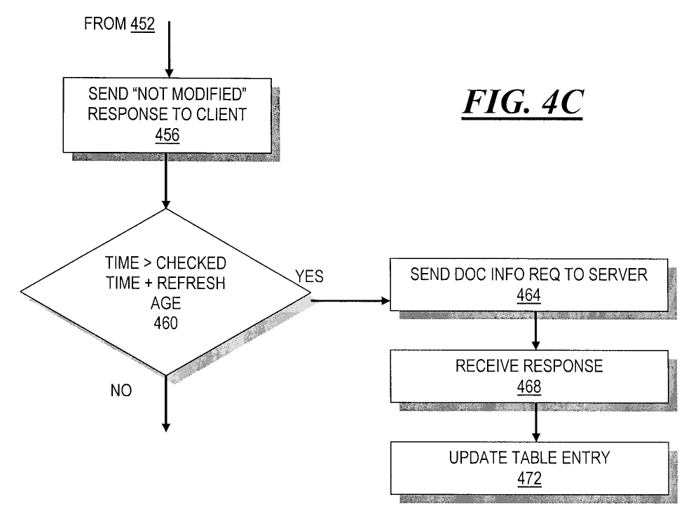

As illustrated in FIG. 4, one embodiment of the invention concerns a method for accelerating web transactions. Upon receiving from a client a document retrieval request for a document (Step 400), the document retrieval request is forwarded to the appropriate server (Step 404). Upon receiving from a server a document retrieval response (Step 408), the document retrieval response is forwarded to the client (Step 412) and a document table entry associated with that particular document (e.g., the document's name) is added or updated (Step 416) to indicate, for example, that the last checked time for that document is the current time, the expiration time for the document as derived from available information in the response (e.g., the time of expiry of the document and the max_age time), and the last modified time for the document as derived from the response. Additionally, old or expired entries may be deleted from the table (Step 420), either immediately as they expire or as new entries are added. If a “not modified” response is received from a server (Step 424), the “not modified” response is forwarded to the client (Step 428).

Upon receiving from a client a freshness verification request for a document specifying an “If-Modified-Since” time (Step 432), then if no table entry exists for that document (Step 436), the freshness verification request is forwarded to the appropriate server (Step 440). If a table entry exists and the current time is greater than the sum of the table entry's last checked time and the maximum table age (Step 444) or the current time is greater than the table entry's expiration time (Step 448) or the table entry's last modified time is greater than the “If-Modified-Since” time (Step 452), then the freshness verification request is also forwarded to the appropriate server (Step 440).

If none of those conditions are satisfied, then a “not modified” response is returned to the client (Step 456). If the current time is greater than the sum of the table entry's last checked time and the refresh age (Step 460), then a document information request is sent to the server for the document requested by the client (Step 464) and when the associated document information response from the server is received (Step 468) then a table entry for that document is updated with information derived from that response (Step 472), namely the last checked time is updated to reflect the current time, the expiration time for the document as derived from available information in the response (e.g., the time of expiry of the document and the max_age time), and the last modified time for the document as derived from the response.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description but instead by the scope of the claims.

What is claimed is:

1. A method for accelerating freshness verification requests, the method comprising:
receiving a document retrieval response from a server;
extracting information from the document retrieval response;
storing the extracted information in a database;
receiving a freshness verification request from a client;
consulting extracted information stored in the database to determine if the freshness verification request can be serviced without forwarding the freshness verification request to a server.

2. The method of claim 1 further comprising transmitting a “not modified” response to the client.

3. The method of claim 2 wherein the “not modified” response comprises an HTTP 304 Not Modified message.

4. The method of claim 1 wherein the document retrieval response comprises an HTTP 200 OK message.

5. The method of claim 1 wherein the freshness verification request comprises an HTTP GET message with an If-Modified-Since condition.

6. The method of claim 1 further comprising:
receiving a document retrieval request from a client;
forwarding the document retrieval request to a server; and
forwarding the document retrieval response to a client.

7. The method of claim 6 wherein the document retrieval request comprises an HTTP GET message without an If-Modified-Since condition.

8. The method of claim 1 further comprising:
transmitting a document information request to the server;
receiving a document information response from the server;
extracting information from the received document information response; and
storing the extracted information in a database.

9. The method of claim 8 wherein the transmittal of a document information request is made contemporaneously upon the receipt of the freshness verification request, subsequent to the receipt of the freshness verification request; or independent of the receipt of the freshness verification request.

10. The method of claim 8 wherein the document information request comprises an HTTP GET message with a range condition.

11. The method of claim 8 wherein the document information response comprises an HTTP 200 OK message with little or no document content.

12. An apparatus for accelerating freshness verification requests, the apparatus comprising:
a receiver for receiving a document retrieval response from a server and a freshness verification request from a client;
a database;
a processor for extracting information from a received document retrieval response and storing the extracted information in the database, and for consulting the database to determine if the freshness verification request can be serviced without forwarding the freshness verification request to a server.

13. The apparatus of claim 12 further comprising a transmitter for transmitting a “not modified” response to the client.

14. The apparatus of claim 13 wherein the transmitter transmits a “not modified” response comprising an HTTP 304 Not Modified message.

15. The apparatus of claim 12 wherein the receiver receives a document retrieval response comprising an HTTP 200 OK message.

16. The apparatus of claim 12 wherein the receiver receives a freshness verification request comprising an HTTP GET message with an If-Modified-Since condition.

17. The apparatus of claim 12 wherein the receiver further receives a document retrieval request from a client, further comprising a transmitter for forwarding the document retrieval request to a server and the document retrieval response to a client.

18. The apparatus of claim 17 wherein the receiver receives a document retrieval request comprising an HTTP GET message without an If-Modified-Since condition.

19. The apparatus of claim 17 wherein the transmitter further transmits a document information request to the server, the receiver further receives a document information response from the server, and the processor extracts information from the received document information response and stores the extracted information in the database.

20. The apparatus of claim 19 wherein the transmitter transmits the document information request contemporaneously upon the receipt of the freshness verification request, subsequent to the receipt of the freshness verification request, or independent of the receipt of the freshness verification request.

21. The apparatus of claim 19 wherein the transmitter transmits a document information request comprising an HTTP GET message with a range condition.

22. The apparatus of claim 19 wherein the receiver receives a document information response comprising an HTTP 200 OK message with little or no document content.
